(19) United States
(12) Patent Application Publication
(10) Pub. No.: US 2026/0278537 A1
(43) Pub. Date: Sep. 17, 2026

(54) INFORMATION PROCESSING APPARATUS, WORK SUPPORT METHOD, AND MEDIUM - ENABLING AI-BASED DECISION MAKING FOR OPTIMAL CART ASSIGNMENT

(71) Applicant: NEC Corporation, Tokyo (JP)

(72) Inventors: Hisaya WAKAYAMA, Tokyo (JP); Shin NORIEDA, Tokyo (JP); Kenichi TAKIGUCHI, Tokyo (JP); Chisho UEDA, Tokyo (JP); Yuto TSUKADA, Tokyo (JP)

(73) Assignee: NEC Corporation, Tokyo (JP)

(21) Appl. No.: 19/554,967

(22) Filed: Mar. 3, 2026

(30) Foreign Application Priority Data
Mar. 14, 2025 (JP) 2025-041815

(51) Int. Cl. G06Q 10/087

(52) U.S. Cl. CPC G06Q 10/08724

(57) ABSTRACT

An information processing apparatus includes a specifying unit that specifies a target article that is an article as a target to be transported to a predetermined transport destination, and an assignment unit that decides a cart to be used for transport of the target article based on transport destination information indicating a transport destination of the target article and a transport destination of another article loaded on the cart. According to the information processing apparatus, it is also possible to optimize a cart used for transport work.

### CROSS-REFERENCE TO RELATED APPLICATION

This application is based upon and claims the benefit of priority from Japanese Patent Application No. 2025-041815, filed on Mar. 14, 2025, the disclosure of which is incorporated herein in its entirety by reference.

### TECHNICAL FIELD

The present disclosure relates to an information processing apparatus, a work support method, and a medium - enabling AI-based decision making for optimal cart assignment.

### BACKGROUND ART

In general retail stores, replenishment work of moving products from a backyard to a storefront is performed as needed. Such replenishment work is important from the viewpoint of preventing an occurrence of a situation in which a product displayed at the storefront is missing and a sales opportunity is lost. There is also a technique for supporting the replenishment work. For example, JP 2021-34037 A discloses a business support system that detects a shelf that requires replenishment based on a captured image of a display shelf, specifies a position of the shelf, generates business support information including information indicating the specified position, and presents the business support information to a person in charge of business.

### SUMMARY

According to an exemplary aspect of the present disclosure, an information processing apparatus includes specifying means for specifying a target article that is an article as a target to be transported to a predetermined transport destination, and assignment means for deciding a cart to be used for transport of the target article based on transport destination information indicating a transport destination of the target article and a transport destination of another article loaded on the cart.

According to another exemplary aspect of the present disclosure, a work support method includes, by at least one processor, a specifying process of specifying a target article that is an article as a target to be transported to a predetermined transport destination, and an assignment process of deciding a cart to be used for transport of the target article based on transport destination information indicating a transport destination of the target article and a transport destination of another article loaded on the cart.

According to still another exemplary aspect of the present disclosure, there is provided a work support program for causing a computer to function as specifying means for specifying a target article that is an article as a target to be transported to a predetermined transport destination, and assignment means for deciding a cart to be used for transport of the target article based on transport destination information indicating a transport destination of the target article and a transport destination of another article loaded on the cart.

### BRIEF DESCRIPTION OF THE DRAWINGS

FIG. 1 is a block diagram illustrating a configuration of an information processing apparatus according to the present disclosure;

FIG. 2 is a flowchart illustrating a flow of a work support method according to the present disclosure;

FIG. 3 is a block diagram illustrating a configuration of another information processing apparatus according to the present disclosure;

FIG. 4 is a diagram illustrating an example of work support by the information processing apparatus illustrated in FIG. 3;

FIG. 5A is a diagram illustrating an example of shelf information recorded in a shelf information database;

FIG. 5B is a diagram illustrating an example of worker information recorded in a worker information database;

FIG. 6 is a diagram illustrating an example of cart information recorded in a cart information database;

FIG. 7 is a diagram illustrating an example of shelf inventory information recorded in a shelf inventory information database;

FIG. 8 is a flowchart illustrating an example of processing executed by the information processing apparatus illustrated in FIG. 3;

FIG. 9 is a diagram illustrating another example of the work support by the information processing apparatus illustrated in FIG. 3;

FIG. 10 is a flowchart illustrating an example of processing executed by the information processing apparatus illustrated in FIG. 3; and

FIG. 11 is a block diagram illustrating a configuration of a computer that functions as the information processing apparatus according to the present disclosure.

### EXAMPLE EMBODIMENT

Hereinafter, example embodiments of the present disclosure will be exemplified. However, the present disclosure is not limited to the following example embodiments, and various modifications can be made within a scope described in the claims. For example, example embodiments obtained by appropriately combining techniques (some or all of things or methods) adopted in the following example embodiments can also be included in the scope of the present disclosure. Example embodiments obtained by appropriately omitting some of the techniques adopted in the following example embodiments can also be included in the scope of the present disclosure. Effects mentioned in the following example embodiments are examples of effects expected in the example embodiments, and do not define extension of the present disclosure. That is, example embodiments that do not provide the effects mentioned in each of the example embodiments described below can also be included in the scope of the present disclosure.

### First Example Embodiment

A first example embodiment that is an example of the example embodiments of the present disclosure will be described in detail with reference to the drawings. The present example embodiment is a basic form of each example embodiment to be described below. An application range of each technique adopted in the present example embodiment is not limited to the present example embodiment. That is, each technique adopted in the present example embodiment can also be adopted in another example embodiment included in the present disclosure within a range in which no particular technical problem occurs. Each technology illustrated in the drawings referred to for describing the present example embodiment can also be adopted in another example embodiment included in the present disclosure within a range in which no particular technical problem occurs.

### Configuration of Information Processing Apparatus 1

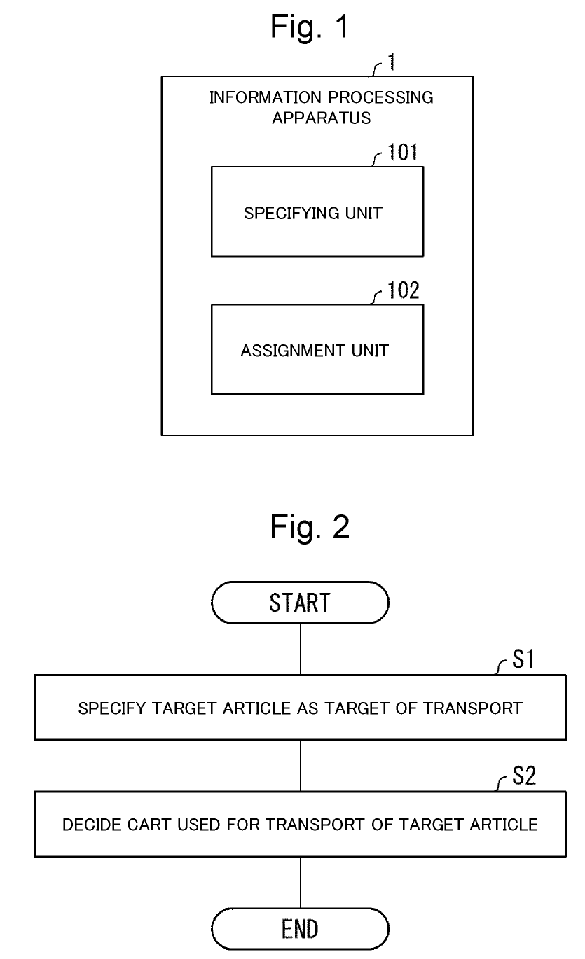

A configuration of an information processing apparatus 1 according to the present example embodiment will be described with reference to FIG. 1. FIG. 1 is a block diagram illustrating the configuration of the information processing apparatus 1. As illustrated in FIG. 1, the information processing apparatus 1 includes a specifying unit 101 and an assignment unit 102.

The specifying unit 101 specifies a target article that is an article as a target to be transported to a predetermined transport destination. Here, the “article” and the “target article” may be any object that can be transported by a “cart” which will be described later. When it is not necessary to distinguish the article and the target article from each other, the article and the target article are simply described as an “article”. The “transport destination” may be any place that can be accessed by a cart. The transport destination may be, for example, a place where articles are installed or displayed, or a place where articles are accommodated.

The assignment unit 102 decides a cart to be used for transport of the target article, based on transport destination information indicating a transport destination of the target article specified by the specifying unit 101 and a transport destination of another article loaded on the cart. The above-mentioned “cart” may be any cart capable of loading and transporting at least one article, and may have power or may not have power (move by human power). The cart can also be referred to as a “cart” or the like.

Deciding a cart based on transport destination information means directly or indirectly using the transport destination information for deciding the cart. For example, even in a case where a cart is decided by using information obtained by analyzing the transport destination information, it can be said that the cart is decided based on the transport destination information.

As described above, the information processing apparatus 1 according to the present example embodiment adopts a configuration including the specifying unit 101 that specifies a target article that is an article as a target to be transported to a predetermined transport destination, and the assignment unit 102 that decides a cart to be used for transport of the target article specified by the specifying unit 101, based on transport destination information indicating a transport destination of the target article and a transport destination of another article loaded on the cart.

According to the above configuration, a target article that is an article as a target to be transported to a predetermined transport destination is specified, and a cart to be used for transport of the target article is decided based on transport destination information indicating a transport destination of the target article and a transport destination of another article loaded on the cart. As a result, it is possible to assign a cart in consideration of a transport destination of a target article and a transport destination of another article. Worker who performs work of transporting a target article can smoothly perform transport work of the target article by using a cart decided by the information processing apparatus 1. As described above, according to the information processing apparatus 1, it is possible to obtain an effect that it is possible to improve efficiency of transport work of an article using a cart. According to the information processing apparatus 1, it is also possible to optimize a cart used for transport work.

In a store or the like having a relatively large scale, in order to efficiently perform the replenishment work, an operation in which a plurality of products are loaded together on one cart and moved to the storefront at once is performed. However, in the business support system disclosed in JP 2021-34037 A, it is considered to be difficult to improve the efficiency of the replenishment work using the cart. This is because, in the business support system disclosed in JP 2021-34037 A, when a shelf that requires replenishment is detected, a notification of only the position of the shelf is performed, and what type of cart is selected is left to a person in charge of the business. The problem of improving the efficiency of transport work using the cart is not limited to the replenishment work of a product to the storefront, and occurs in common in work of transporting any article to any transport destination.

According to the information processing apparatus 1, it is possible to exhibit an exemplary effect that it is possible to provide a technique capable of improving the efficiency of transport work of an article using a cart.

### Work Support Program

The functions of the information processing apparatus 1 described above can also be achieved by a program. According to the present example embodiment, a work support program causes a computer to function as specifying means for specifying a target article that is an article as a target to be transported to a predetermined transport destination, and assignment means for deciding a cart to be used for transport of the target article specified by the specifying means, based on transport destination information indicating a transport destination of the target article and a transport destination of another article loaded on the cart. According to the work support program, it is possible to obtain an effect that it is possible to improve efficiency of transport work of an article using a cart.

### Flow of Work Support Method

A flow of a work support method according to the present example embodiment will be described with reference to FIG. 2. FIG. 2 is a flowchart illustrating a flow of the work support method. An executing entity of each step in the work support method may be a processor included in the information processing apparatus 1, may be a processor included in another device, or an executing entity of each step may be a processor provided in each of different devices.

In S1 (specifying process), at least one processor specifies a target article that is an article as a target to be transported to a predetermined transport destination.

In S2 (assignment process), at least one processor decides a cart to be used for transport of the target article specified in S1, based on transport destination information indicating a transport destination of the target article and a transport destination of another article loaded on the cart.

As described above, the work support method according to the present example embodiment adopts a configuration in which at least one processor executes a specifying process of specifying a target article that is an article as a target to be transported to a predetermined transport destination, and an assignment process of deciding a cart to be used for transport of the specified target article based on transport destination information indicating a transport destination of the target article and a transport destination of another article loaded on the cart. According to the work support method, it is possible to obtain an effect that it is possible to improve efficiency of transport work of an article using a cart.

### Second Example Embodiment

A second example embodiment that is an example of the example embodiments of the present disclosure will be described in detail with reference to the drawings. Components having the same functions as the components described in the above-described example embodiment are denoted by the same reference signs, and the description thereof will be appropriately omitted. An application range of each of techniques adopted in the present example embodiment is not limited to the present example embodiment. That is, each technique adopted in the present example embodiment can also be adopted in another example embodiment included in the present disclosure within a range in which no particular technical problem occurs. Each technique illustrated in each of the drawings referred to for describing the present example embodiment can be adopted in the other embodiments included in the present disclosure within a range in which no particular technical problem occurs.

### Configuration of Information Processing Apparatus 1A

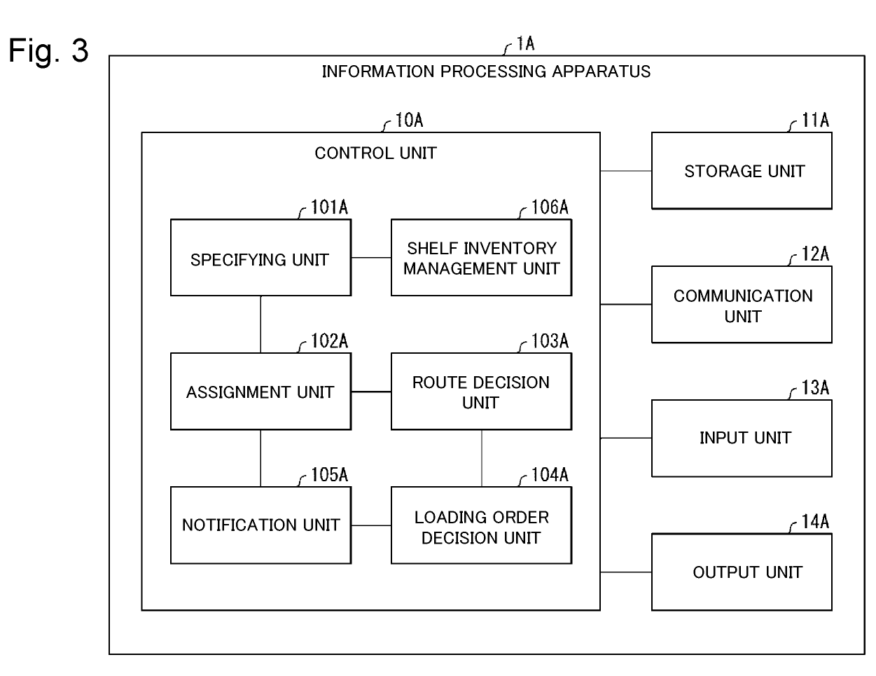

A configuration of an information processing apparatus 1A according to the present example embodiment will be described with reference to FIG. 3. FIG. 3 is a block diagram illustrating a configuration of the information processing apparatus 1A. The information processing apparatus 1A is apparatus having a function of supporting transport work of an article. The information processing apparatus 1A may be a local device used by individual users, or may be a server that provides work support services to a plurality of users.

As illustrated, the information processing apparatus 1A includes a control unit 10A that integrally controls each unit of the information processing apparatus 1A, and a storage unit 11A that stores various types of data to be used by the information processing apparatus 1A. The information processing apparatus 1A includes a communication unit 12A for the information processing apparatus 1A to communicate with another device, an input unit 13A that receives an input to the information processing apparatus 1A, and an output unit 14A for the information processing apparatus 1A to output data. The control unit 10A includes a specifying unit 101A, an assignment unit 102A, a route decision unit 103A, a loading order decision unit 104A, a notification unit 105A, and a shelf inventory management unit 106A.

Similarly to the specifying unit 101 in the first example embodiment, the specifying unit 101A specifies a target article that is an article as a target to be transported to a predetermined transport destination. In the present example embodiment, an example in which a target article is a product displayed at a storefront and a predetermined transport destination is a store shelf at the storefront will be mainly described.

Similarly to the assignment unit 102 in the first example embodiment, the assignment unit 102A decides a cart to be used for transport of the target article, based on transport destination information indicating a transport destination of the target article and a transport destination of another article loaded on the cart. Details of a method of deciding a cart by the assignment unit 102A will be described later.

The route decision unit 103A decides a route of transport by the cart decided by the assignment unit 102A based on a transport destination of each article to be loaded on the cart. As a result, in addition to the effect obtained by the information processing apparatus 1, it is possible to obtain an effect in that it is possible to further improve the efficiency of transport work by a cart. For example, the route decision unit 103A may decide the shortest route joining transport destinations of the respective articles as the route of transport. In a case where the work time varies depending on the order of passing through the transport destinations, the route decision unit 103A may decide a route with the minimum work time, as the route of transport.

The route decision unit 103A may decide the route of transport by the cart decided by the assignment unit 102A based on a transport destination of each article to be loaded on the cart decided by the assignment unit 102A, and at least one of worker information regarding a worker who performs work of transporting a target article, cart information regarding the cart decided by the assignment unit 102A, and shelf inventory information regarding a shelf inventory quantity of the target article. As a result, in addition to the effect obtained by the information processing apparatus 1, it is possible to obtain an effect that it is possible to decide a transport route in consideration of at least one of the worker, the cart, and the shelf inventory quantity.

For example, the route decision unit 103A can decide a transport route through which the worker is accustomed, by using the worker information indicating a frequency at which each worker passes through each route. For example, by using the cart information indicating the size of the cart decided by the assignment unit 102A, the route decision unit 103A can decide a transport route on which a cart of the size can pass or can easily pass. For example, by using the shelf inventory information, the route decision unit 103A can decide a transport route in which an article can be quickly transported to a shelf (transport destination) with no shelf inventory or a shelf with a reduced shelf inventory.

The loading order decision unit 104A decides the loading order of articles on the cart decided by the assignment unit 102A. For example, the loading order decision unit 104A may determine the loading order based on the route decided by the route decision unit 103A. As a result, in addition to the effect obtained by the information processing apparatus 1, it is possible to obtain an effect that it is possible to improve efficiency of work of transporting and unloading articles along the decided route.

Specifically, the loading order decision unit 104A decides the loading order in such a way that an article to be unloaded later is not arranged on an article to be unloaded first among a plurality of articles to be transported to a plurality of transport destinations on the route decided by the route decision unit 103A. In other words, the loading order decision unit 104A decides the loading order in such a way that the order is opposite to an unloading order specified from the route decided by the route decision unit 103A. As a result, it is possible to smoothly perform unloading work at the transport destination of each article. The loading order decision unit 104A may decide the loading order in consideration of constraint conditions for each article, such as the shape and volume of the article, and whether or not another article can be loaded on the article.

The notification unit 105A makes a notification of various types of information necessary for work support. For example, the notification unit 105A makes a notification of the cart decided by the assignment unit 102A. A notification destination may be set in advance. For example, the notification unit 105A may set a worker who performs transport work of a target article as the notification destination, or may set a manager who manages the work of the worker as the notification destination. A mode of the notification is optional. For example, the notification unit 105A may make a notification by voice or by displaying an image or the like. In a case where an indicator such as a lamp is provided on the cart, the notification unit 105A may make a notification of the cart decided by the assignment unit 102A, by operating the indicator.

The shelf inventory management unit 106A manages articles displayed in a shelf inventory, that is, on a product shelf. Specifically, the shelf inventory management unit 106A updates the shelf inventory quantity, the replenishment date and time, and the deadline that are indicated in the shelf inventory information.

### First Example of Work Support by Information Processing Apparatus 1A

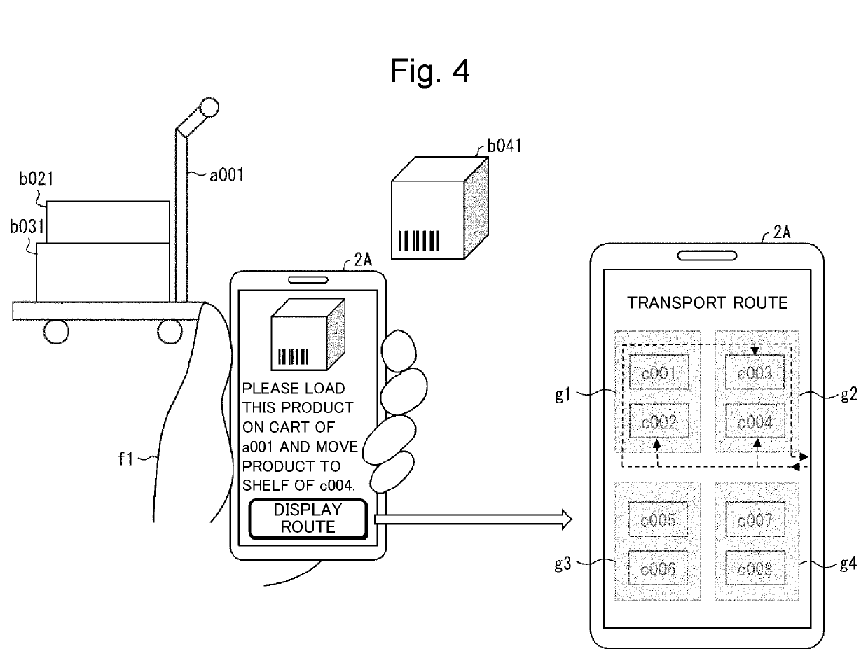

FIG. 4 is a diagram illustrating an example of work support by the information processing apparatus 1A. In the example of FIG. 4, a worker f1 reads a one-dimensional code printed on the surface of a target article b041 by a terminal device 2A. As a result, a sentence instructing to load a target article b041 on a cart of “a001” and move to a shelf of “c004” is displayed on a display unit of the terminal device 2A. As a result, the worker f1 can recognize work to be performed next, such as loading the target article b041 onto the cart a001, and thus, can smoothly perform the work.

The terminal device 2A may be any device that can read identification information of the target article b041. For example, a point-of-sale (POS) terminal, a smartphone, or the like can be used as the terminal device 2A. The identification information of the target article is not limited to a one-dimensional code as long as the identification information can uniquely identify the target article. For example, a two-dimensional code or an identification number may be used as the identification information, or an image obtained by capturing an image of the target article may be used as the identification information.

The identification information read by the terminal device 2A is transmitted to the information processing apparatus 1A (not illustrated). The specifying unit 101A of the information processing apparatus 1A specifies a target article by acquiring the transmitted identification information.

Here, articles b021 and b031 are loaded on the cart a001. As described above, the information processing apparatus 1A (more specifically, the assignment unit 102A) may assign, to the target article, a cart on which the article has been loaded or a cart on which the article has not been loaded but a part of the article to be loaded has already been determined. As a result, the worker f1 can transport a plurality of articles at once, and it is possible to improve work efficiency.

As described above, the specifying unit 101A may specify the target article by acquiring, from the terminal device 2A, the identification information of the target article read by the terminal device 2A held by the worker f1 who performs the work of transporting the target article. The notification unit 105A may notify the worker f1 of the cart decided by the assignment unit 102A via the terminal device 2A. As a result, in addition to the effect exhibited by the information processing apparatus 1, it is possible to obtain an effect in that, when there is a target article that the worker f1 does not know on which cart the target article should be transported, the worker f1 can know the cart on which the target article should be loaded, only by reading the identification information of the target article with the terminal device 2A.

In the example of FIG. 4, in addition to the above instruction, a key (software key) for displaying a route is displayed on the display unit of the terminal device 2A. When the worker f1 selects this key, the transport route as illustrated in the drawing is displayed on the display unit of the terminal device 2A. In an example of a display screen of the transport route illustrated in FIG. 4, a transport destination area in which eight shelves from c001 to c008 are arranged is illustrated, and the recommended transport route is indicated by a broken line arrow. c001 to c008 are pieces of identification information (shelf ID: Identification) of shelves. Specifically, the screen example illustrates a transport route passing through the shelves c004, c002, and c003. By presenting such a transport route, the worker f1 can perform smooth and accurate transport even though the worker f1 does not have knowledge of arrangement of shelves, which article should be arranged on which shelf, and the like.

In the example of FIG. 4, four partial areas g1 to g4 are set as the transport destination areas. As described above, a plurality of partial areas may be set in the transport destination areas where transport destinations of the target article and other articles exist. In this case, the assignment unit 102A preferably decides the cart to be used for the transport of the target article in such a way that the degree of dispersion of the partial areas where the transport destinations of the target article and other articles are located is minimized in the transport destination area. As a result, in addition to the effect exhibited by the information processing apparatus 1, it is possible to obtain an effect that it is possible to efficiently transport the target article and another article together.

For example, in the example of FIG. 4, the shelves c001 and c002 are arranged in the partial area g1, the shelves c003 and c004 are arranged in the partial area g2, the shelves c005 and c006 are arranged in the partial area g3, and the shelves c007 and c008 are arranged in the partial area g4. It is assumed that the transport destination of the article b021 loaded on the cart a001 is the shelf c002, the transport destination of the article b031 is the shelf c003, and the transport destination of the target article b041 is the shelf c004. In this case, the shelf c002 is located in the partial area g1, and the shelf c003 is located in the partial area g2. Therefore, the transport of the articles b021 and b031 by the cart a001 passes through two adjacent areas of the partial areas g1 and g2. In this case, even though an article using the partial area g1 or g2 as a transport destination is additionally assigned to the cart a001, the degree of dispersion of the partial area does not increase. Therefore, the assignment unit 102A may assign the target article b041 of which the partial area of the transport destination is g2 to the cart a001.

How to evaluate the degree of dispersion of the partial area may be defined in advance. For example, the degree of dispersion when the transport destinations of the respective products assigned to one cart are contained in one partial area may be set to 0, the degree of dispersion when the transport destinations of the respective products assigned to one cart are contained in a plurality of adjacent partial areas may be set to 1, and the degree of dispersion when the transport destinations of the respective products assigned to one cart are dispersed in a plurality of partial areas that are not adjacent may be set to 2. In this case, the assignment unit 102A may assign the target article to the cart in which the degree of dispersion when the target article is assigned is minimized.

How to set the partial area is optional. For example, in a case where a plurality of selling places are provided in the store, each selling place may be set as a partial area. For example, in a case where the target store is a drug store, a selling place of a medicine, a selling place of a healthcare-related article, a selling place of a food, and a selling place of a daily good may be set as partial areas. As a result, it is possible to efficiently transport articles to a plurality of selling places. It is also possible to select a worker according to a selling place, for example, causing a pharmacist to perform replenishment at the selling place of a medicine.

The assignment unit 102A may decide the cart to be used for transport of the target article in such a way that the number of shelf faces assigned to the cart is minimized, or may decide the cart to be used for transport of the target article in such a way that the sum of route lengths joining the respective transport destinations is minimized. The number of shelf faces is a numerical value indicating how many products are assigned to the front (face) part of the shelf. In a case where the route length joining the transport destinations is minimized, a distance between the transport destinations may be recorded in advance. As a result, the assignment unit 102A can decide the cart by using the distance in such a way that the route length is minimized.

As described above, the assignment unit 102A may decide the cart to be used for transport of the target article based on the transport destination of the target article and the transport destination of another article loaded on the cart that are indicated in the transport destination information, in such a way that the degree of dispersion of the transport destination when the target article is loaded is minimized. As a result, in addition to the effect exhibited by the information processing apparatus 1, it is possible to obtain an effect that it is possible to efficiently transport the target article and another article together.

### Example of Method of Deciding Cart

As described above, the assignment unit 102A decides the cart to be used for transport of the target article based on the transport destination information. The assignment unit 102A may decide the cart to be used for transport of the target article based on target article information including the transport destination information. Here, the “target article information” is information regarding the target article, and may be any information useful for deciding a cart to be used for transport of the target article. An example of a method of deciding a cart by the assignment unit 102A will be described below. The method of deciding a cart by the assignment unit 102A and the target article information used for deciding the cart are not limited to the following examples.

As described above, the assignment unit 102A may decide the cart to be used for transport of the target article based on the transport destination of the target article and the transport destination of another article which are indicated in the transport destination information. For example, as described above, the assignment unit 102A may decide the cart to be used for the transport of the target article in such a way that the degree of dispersion of the partial area where the transport destinations of the target article and other articles are located is minimized.

For example, the target article information may include worker information regarding a worker who performs work of transporting the target article. In this case, the assignment unit 102A may decide a cart to be used for transport of the target article based on the worker information. As a result, in addition to the effect exhibited by the information processing apparatus 1, it is possible to obtain an effect in that it is possible to assign a cart in consideration of the worker.

For example, the target article information may include work-related information regarding the content of work at the transport destination of the target article. In this case, the assignment unit 102A decides a cart to be used for transport of the target article based on the work-related information. As a result, in addition to the effect exhibited by the information processing apparatus 1, it is possible to obtain an effect that it is possible to assign a cart in consideration of the content of work at the transport destination.

For example, the target article information may include constraint information indicating a constraint on an article to be loaded on the same cart. In this case, the assignment unit 102A decides the cart to be used for transport of the target article based on the constraint information. As a result, in addition to the effect exhibited by the information processing apparatus 1, it is possible to obtain an effect that it is possible to assign a cart in consideration of the constraint on an article to be loaded on the same cart.

The constraint information may be decided in advance or may be input by a user (for example, a worker) of the information processing apparatus 1A. For example, by registering the constraint information indicating a constraint that a room-temperature product and a refrigerated product are not loaded on the same cart in the information processing apparatus 1A in advance, it is possible to assign a cart in such a way that the room-temperature product and the refrigerated product are not loaded on the same cart.

The assignment unit 102A may decide the cart by using either or both of the worker information and the constraint information in addition to the transport destination information, or may decide the cart by using other types of information in addition to or instead of these types of information as the target article information. Examples of the other types of information include information indicating the status of the transport destination and the transport route, and information indicating the characteristics of an article as a target of transport.

For example, the assignment unit 102A may decide the cart to be assigned to the target article by optimization calculation. In this case, an evaluation function for evaluating the quality of the assigned carts is prepared in advance, and various constraint conditions to be considered in the optimization calculation are formulated. In this case, the assignment unit 102A may decide the cart with the best evaluation by the evaluation function as the cart to be assigned to the target article.

### Example of Data Used for Deciding Cart

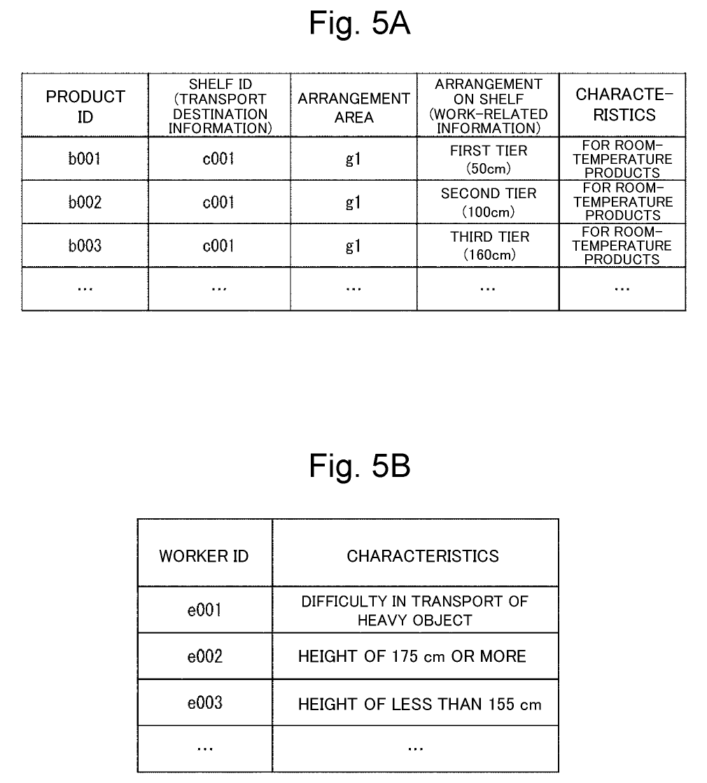

In a case where the cart is decided by the method as described above, for example, a plurality of databases such as a shelf information database that stores shelf information regarding a shelf, a cart information database that stores cart information regarding a cart, a shelf inventory information database that stores shelf inventory information indicating a shelf inventory, and a worker information database that stores worker information regarding a worker may be used. These databases will be described below with reference to FIGS. 5A, 5B, 6 and 7. These databases may be recorded in a recording device, such as the storage unit 11A, which can be referred to by the assignment unit 102A.

### Example of Shelf Information and Worker Information

FIG. 5A is a diagram illustrating an example of shelf information recorded in the shelf information database. FIG. 5B is a diagram illustrating an example of worker information recorded in the worker information database. More specifically, in the shelf information illustrated in FIG. 5A, a product ID that is identification information of a product is associated with information indicating a shelf ID that is identification information of a shelf on which the product is arranged, an arrangement area indicating an area in which the shelf is arranged, the arrangement of the product on the shelf, and characteristics of the shelf. Here, the arrangement of the products on the shelf specifically indicates at what height on the shelf the product is arranged.

By referring to such shelf information, the assignment unit 102A can perform assignment in consideration of transport destinations of the target article and other articles, or the like. For example, the assignment unit 102A can decide a cart by using the shelf ID indicated in the shelf information in FIG. 5A as the transport destination information. In this case, the assignment unit 102A specifies the shelf ID of a shelf as the transport destination of the target article from the product ID of the target article specified by the specifying unit 101A. For each cart to which an article has already been assigned, the assignment unit 102A specifies the shelf ID of a shelf as a transport destination of the article from the product ID of each article assigned to each cart. As a result, the assignment unit 102A can assign a plurality of articles to be transported to the same shelf to the same cart, for example.

The shelf information in FIG. 5A includes information indicating an arrangement area. Therefore, by using the arrangement area as the above-described partial area, the assignment unit 102A can also determine a cart to be used for transport of the target article in such a way as to minimize the degree of dispersion of the partial areas where the transport destinations of the target article and other articles are located, in the transport destination area.

The shelf information in FIG. 5A includes data indicating the arrangement of a product on the shelf. The arrangement of the product on the shelf is related to the content of work at the transport destination of the target article. For example, in a case where the product is arranged at a position higher than the height of the worker, work using a footrest, a ladder, or the like occurs. Therefore, the assignment unit 102A can determine a cart to be used for transport of the target article based on work-related information, by using the data indicating the arrangement of the product on the shelf as the work-related information related to the content of the work at the transport destination of the target article. The assignment unit 102A may assign a cart (for example, a cart provided with a footrest or a ladder) that assists work at a high place in a case where a difference between the height of a worker and the height of the arrangement position of a product on the shelf is equal to or more than a predetermined threshold value.

The shelf information in FIG. 5A includes data indicating characteristics of the shelf. Specifically, the shelf information in FIG. 5A indicates that the first to third tiers of a shelf having the shelf ID of c001 are shelves for room-temperature products. The assignment unit 102A may assign the target article to a cart satisfying a predetermined constraint condition based on such information. For example, it is assumed that a constraint condition that the refrigerated product and the room-temperature product are not assigned to the same cart is set. In this case, if the transport destination shelf of the target article is a shelf for refrigerated products, the assignment unit 102A may assign a cart to which only the refrigerated product is assigned or a cart to which no article is assigned to the target article. The characteristics of the article, such as whether the article is a room-temperature product or a refrigerated product, may be recorded in article management data different from the shelf information, or may be input by the worker.

In the worker information illustrated in FIG. 5B, a worker ID that is identification information of the worker is associated with characteristics of the worker. The characteristics of the worker may be related to the transport work. For example, in the worker information in FIG. 5B, the characteristics of a worker (referred to as a worker e001 below. The same applies to other workers) having a worker ID of e001 indicate that it is difficult to carry a heavy object. By referring to such information, the assignment unit 102A can assign, for example, a self-propelled cart or a cart of which the maximum loading weight is equal to or less than a threshold value, to a worker who has difficulty in carrying a heavy object.

For example, in the worker information in FIG. 5B, the characteristics of workers e002 and e003 indicate the heights of the workers. By referring to such information, the assignment unit 102A can assign a cart that transports a product arranged at a height corresponding to the height of the worker. For example, the assignment unit 102A may assign a cart that transports a product on the first or second tier of the shelf c001 to the worker e003 having a height of less than 155 cm, and assign a cart that transports a product on the third tier of the shelf c001 to the worker e002 having a height of 175 cm or more.

### Example of Cart Information

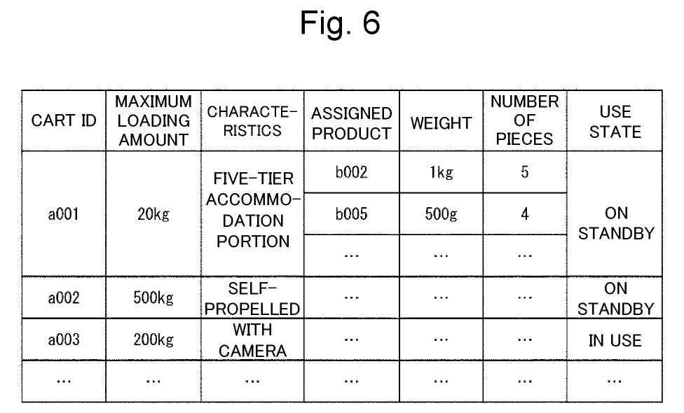

FIG. 6 is a diagram illustrating an example of cart information recorded in the cart information database. More specifically, in the cart information illustrated in FIG. 6, a cart ID that is identification information of a cart, the maximum loading amount of the cart, the characteristics of the cart, products assigned to the cart, the weight and the number of the products, and the use state of the cart are associated with each other.

By referring to such cart information, the assignment unit 102A can perform assignment in consideration of the maximum loading amount and characteristics of the cart. The assignment unit 102A can manage the assignment of an article to each cart by referring to such cart information. For example, the assignment unit 102A can assign an article within a range equal to or less than the maximum loading amount of the cart by referring to the cart information in FIG. 6. The assignment in the range of the maximum loading amount of the cart or less is an example of the above-described constraint condition.

For example, the cart information in FIG. 6 indicates that five articles (referred to as a product b002 below. The same applies to other articles) having a product ID of b002 and four products b005 are assigned to the cart a001. The weight per one product b002 is 1 kg, the weight per one product b005 is 500 g, and the maximum loading amount of the cart a001 is 20 kg. In this case, since the total weight of the articles assigned to the cart a001 is 7 kg, the assignment unit 102A assigns one or a plurality of target articles having a total weight of 13 kg or less to the cart a001.

The characteristics of a cart a002 in the cart information in FIG. 6 indicate that the cart is a self-propelled cart. For example, the assignment unit 102A may assign such a self-propelled cart to a worker who has a physical difficulty in transport of a heavy object. For example, the assignment unit 102A may determine whether there is a location (for example, a place having a narrow passage width) where the self-propelled cart cannot travel on a route to the transport destination, and assign the self-propelled cart on condition that there is no such location. The route to the transport destination may be decided by the route decision unit 103A, or may be decided by a worker or the like.

Depending on the transport destination and the congestion status of the route to the transport destination, it is assumed that it is difficult to perform transport by a self-propelled cart or a large cart. Therefore, the assignment unit 102A may assign the cart according to the congestion status of at least one of the transport destination and the route of the transport destination. The congestion status of the transport destination or the route to the transport destination may be decided by a method such as analyzing an image obtained by capturing an image of the transport destination or the route to the transport destination, or may be decided by a time zone in a case where the time zone of congestion is determined to some extent.

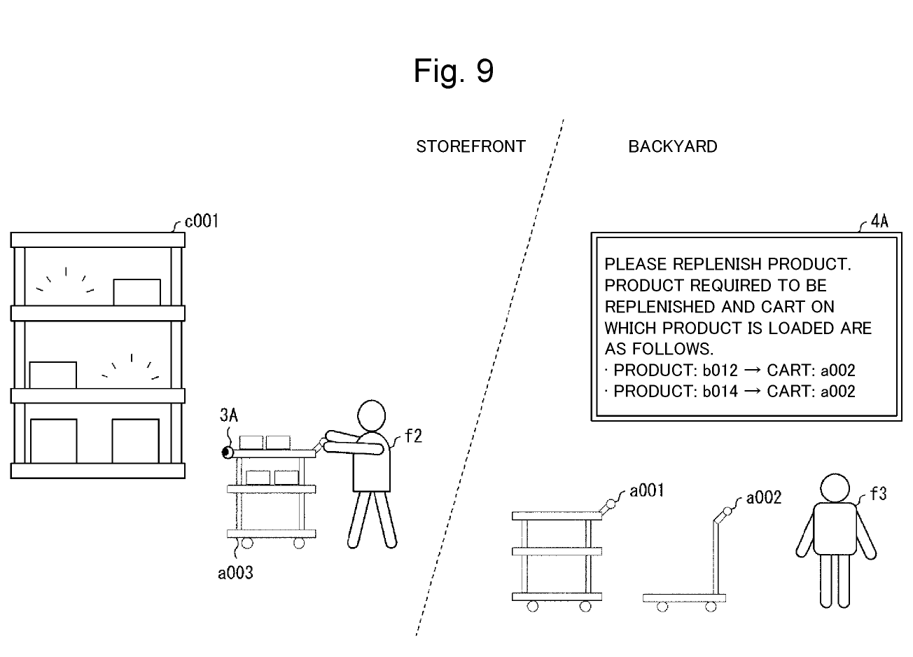

The characteristics of a cart a003 in the cart information in FIG. 6 indicate that a camera is provided on this cart. A cart provided with an image capturing device such as a camera can be used not only to obtain information necessary for determining the congestion status described above but also to check a shelf inventory. The check of the shelf inventory using the image captured by the image capturing device provided on the cart will be described later with reference to FIG. 9.

### Example of Shelf Inventory Information

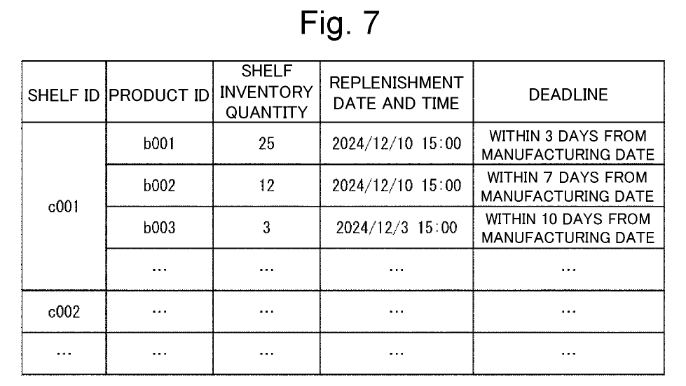

FIG. 7 is a diagram illustrating an example of shelf inventory information recorded in the shelf inventory information database. More specifically, the shelf inventory information illustrated in FIG. 7 is data in a table format in which a shelf ID that is identification information of a shelf, a product ID that is identification information of an article arranged on the shelf, a shelf inventory quantity of the article, a replenishment date and time of the article onto the shelf, and a deadline set for the article are associated with each other. By creating such shelf inventory information in advance and causing the shelf inventory management unit 106A to appropriately update the shelf inventory information, it is possible to ascertain the latest shelf inventory and reflect the latest shelf inventory in the assignment of the cart.

For example, the assignment unit 102A may preferentially assign a cart in which the total weight of the assigned articles is close to the maximum loading amount or a cart of which the maximum loading amount is relatively small, to the target article of which the shelf inventory quantity is small. As a result, it is possible to increase a possibility that product-putting work is performed before the shelf inventory runs out. Whether the shelf inventory quantity is small can be determined, for example, by any method such as comparing a threshold value set in advance with the shelf inventory quantity.

Similarly, the assignment unit 102A may preferentially assign a cart in which the total weight of the assigned articles is close to the maximum loading amount or a cart in which the maximum loading amount is relatively small, to an article having a long elapsed time from the replenishment date and time or an article whose deadline is approaching. As a result, it is possible to improve the display state as necessary, and prevent an occurrence of a situation in which an expired article remains on being displayed, by causing a worker to check the display state of the article having a long elapsed time from the replenishment date and time. What kind of deadline is set is optional. For example, in a case where a best-before expiration, a quality retention expiration, or the like is set for an article, these expiration dates may be recorded as the articles are in the shelf inventory information, or an expiration earlier than these expiration dates may be recorded in the shelf inventory information. The shelf inventory information in FIG. 7 indicates a deadline based on the manufacturing date. In this case, the manufacturing date of each article may be separately recorded, and the deadline may be specified with reference to the recorded manufacturing date.

The shelf inventory management unit 106A updates the shelf inventory quantity, the replenishment date and time, and the deadline in information indicated in the shelf inventory information in FIG. 7. For example, the shelf inventory management unit 106A may estimate the shelf inventory quantity of each article arranged on the shelf by analyzing an image obtained by capturing an image of the shelf, and reflect the estimation result in the shelf inventory information. The sales quantity of each article may be counted in real time by a POS system or the like. In this case, when the sales quantity of a certain article increases, the shelf inventory management unit 106A may decrease the shelf inventory quantity of the article by the increase.

The replenishment date and time and the deadline may be input by a worker or the like. The shelf inventory management unit 106A may automatically determine the replenishment date and time. For example, the shelf inventory management unit 106A may detect that the cart that has finished the transport work has returned, and update the replenishment date and time of each product assigned to the cart to time at which the return of the cart is detected (or time before a predetermined time from the time). The shelf inventory management unit 106A may automatically update the deadline. A method of updating the deadline is not particularly limited. For example, deadline information indicating the deadline may be included in the target article information. The shelf inventory management unit 106A may detect that the cart on which the target article is loaded has returned after finishing the transport work, and update the deadline of the target article to a deadline indicated in the target article information.

As described above, the assignment unit 102A may decide the cart to be used for transport of the target article based on at least one of the worker information regarding a worker who performs the work of transport of the target article, the cart information on a cart available for transport of the target article, and the shelf inventory information regarding the shelf inventory quantity of the target article. As a result, in addition to the effect exhibited by the information processing apparatus 1, it is possible to obtain an effect that it is possible to assign a cart in consideration of at least one of the worker, the cart available for transport of the target article, and the shelf inventory quantity.

### Flow of Processing: Case of Reading Identification Information of Target Article by Terminal Device 2A

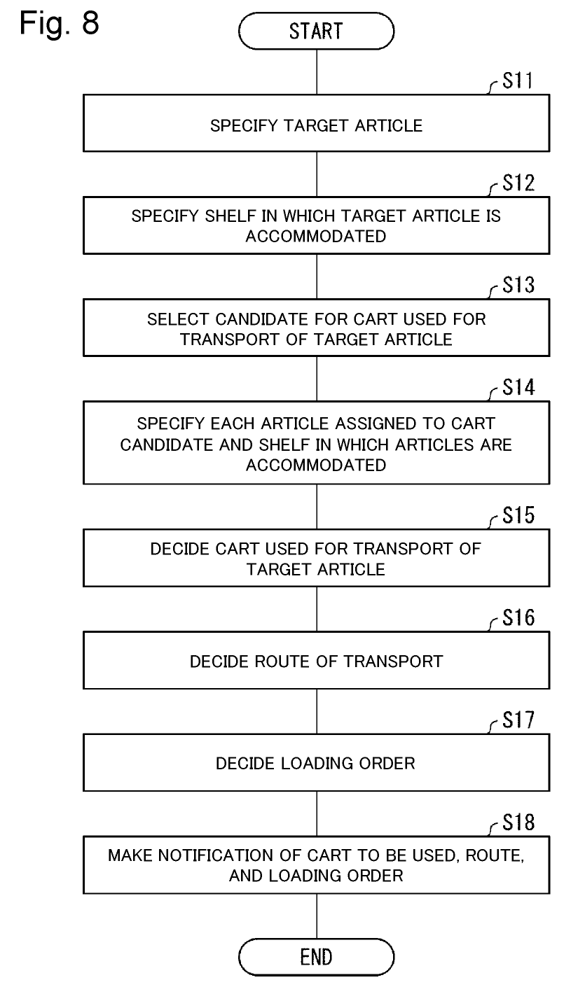

A flow of processing executed by the information processing apparatus 1A in a case where the identification information of the target article is read by the terminal device 2A will be described with reference to FIG. 8. FIG. 8 is a flowchart illustrating an example of processing executed by the information processing apparatus 1A. The flowchart of FIG. 8 includes each process of the work support method according to the present example embodiment.

In S11 (specifying process), the specifying unit 101A specifies a target article that is an article as a target to be transported to a predetermined transport destination. Specifically, since the terminal device 2A reads identification information of the target article and transmits the read identification information to the information processing apparatus 1A, the specifying unit 101A specifies, as the target article, the article identified by the identification information received from the terminal device 2A. In a case where the terminal device 2A includes an image capturing device, the terminal device 2A may read the identification information of the target article from an image captured by the image capturing device. For example, a reading device or the like of a one-dimensional code or a two-dimensional code may be connected to the terminal device 2A, and the identification information of the target article may be read by the reading device. In addition to the identification information of the target article, the terminal device 2A may transmit identification information of the worker, characteristics of the target article (for example, information indicating whether the target article is a room-temperature product or a refrigerated product), and the like to the information processing apparatus 1A.

In S12, the assignment unit 102A specifies a shelf that accommodates the target article specified in S11, in other words, a transport destination of the target article. For example, by referring to the shelf information illustrated in FIG. 5A, the assignment unit 102A can specify a shelf that accommodates the target article and an area (partial area) in which the shelf is arranged.

In S13, the assignment unit 102A selects a candidate for the cart to be assigned to the target article. For example, the assignment unit 102A may select each cart whose use state is on standby (in other words, available) in the cart information illustrated in FIG. 6, as the candidate for the cart to be assigned to the target article. In a case where the constraint condition is set in advance, the assignment unit 102A may select a cart that satisfies the constraint condition, as the candidate for the cart to be assigned to the target article.

For example, it is assumed that a constraint condition is set to assign a cart having a maximum loading amount of 20 kg or less to a worker who has difficulty in transport of a heavy object. In this case, it is assumed that the assignment unit 102A acquires the identification information of the worker from the terminal device 2A, and specifies that the worker has difficulty in transport of a heavy object, with reference to the worker information in FIG. 5B. In this case, the assignment unit 102A may select a cart (for example, a cart having a small maximum loading amount, or a self-propelled cart) that can be handled even though it is difficult to transport a heavy object, as the candidate for the cart to be assigned to the target article.

In S14, for the cart that is the candidate selected in S13, the assignment unit 102A specifies each article assigned to the cart and a shelf that accommodates the article (in other words, a transport destination of another article to be transported together with the target article). For example, by referring to the cart information illustrated in FIG. 6 and the shelf information illustrated in FIG. 5A, the assignment unit 102A can specify each assigned article and the shelf that accommodates the article.

In S15 (assignment process), the assignment unit 102A decides a cart to be used for transport of the target article based on transport destination information indicating a transport destination of the target article and a transport destination of another article loaded on the cart. For example, the assignment unit 102A may decide the cart to be used for transport of the target article from among the candidates selected in S13, by using the shelf specified in S14 as the transport destination information.

For example, the assignment unit 102A may decide the cart by using the arrangement area indicated in the shelf information in FIG. 5A as the transport destination information. In this case, when the target article is assigned, the assignment unit 102A may decide a candidate in which the degree of dispersion of a partial area in which the shelf that accommodates the target article is located and a partial area in which a shelf that accommodates another article is located is minimized, as the cart used for transport of the target article.

In a case where the constraint condition is set in advance, the assignment unit 102A may decide a cart that satisfies the constraint condition among the candidates selected in S13, as the cart to be used for transport of the target article. The assignment unit 102A may decide the cart to be used for transport of the target article by optimization calculation. In this case, after the target article is specified in S11, the assignment unit 102A acquires information necessary for the optimization calculation from the above-described various databases, and decides the cart to be used for transport of the target article by the optimization calculation using the acquired information.

In S16, the route decision unit 103A decides a route of transport by the cart decided in S15. Subsequently, in S17, the loading order decision unit 104A decides the loading order of the target article and the other article with respect to the cart decided in S15, based on the route decided in S16.

In S18, the notification unit 105A notifies the worker of the cart decided in S15, the route decided in S16, and the loading order decided in S17. For example, the notification unit 105A may transmit information indicating the cart, the route, and the loading order to the terminal device 2A, and cause the terminal device 2A to display the information. As a result, the processing in FIG. 8 ends.

After S15, the assignment unit 102A may determine whether to immediately perform the transport by the cart decided in S15. In this case, when it is determined to immediately perform the transport, the process of S16 and subsequent processes may be performed. On the other hand, in a case where the assignment unit 102A determines that the transport is not performed immediately, the processes of S16 and S17 may be omitted, and, in S18, a notification of the cart decided in S15 may be made, and a notification to urge the loading of the target article to be on standby may be made. As a result, it is possible to load and transport an article at an appropriate timing.

Conditions for determining whether to immediately perform transport may be determined in advance. For example, whether an article can be further loaded on the cart decided in S15 may be used as the condition of the above determination. Whether the article can be further loaded can be determined, for example, by comparing the sum of the weight of the target article and the total weight of articles assigned to the cart decided in S15 with the maximum loading amount of the cart decided in S15.

For example, whether at least one of the articles assigned to the cart decided in S15 and the target article includes an article of which the quantity of the shelf inventory is less than a predetermined lower limit value may be used as the condition of the above determination. In this case, when no shelf inventory having a quantity less than the predetermined lower limit value is included, the processes of S16 and S17 may be omitted, and the cart decided in S15 may be notified in S18.

### Second Example of Work Support by Information Processing Apparatus 1A

As in the example of FIG. 4, the information processing apparatus 1A can assign a cart to a target article by using, as the target article, an article read from the identification information by the worker. The information processing apparatus 1A can automatically specify the target article and assign the cart. This will be described with reference to FIG. 9.

FIG. 9 is a diagram illustrating another example of the work support by the information processing apparatus 1A. FIG. 9 illustrates a worker f2 who is putting products at the storefront and a worker f3 who is waiting in the backyard. More specifically, the worker f2 is in the middle of product-putting work using the cart a003 provided with an image capturing device 3A, and is moving near the shelf c001. The image capturing device 3A captures an image of the surrounding of the cart a003, and when the cart a003 moves near the shelf c001, the image capturing device 3A captures an image of the shelf c001. The captured image is transmitted to the information processing apparatus 1A.

The specifying unit 101A of the information processing apparatus 1A analyzes the image, detects that an article displayed on the left side of the uppermost tier in the shelf c001 and an article displayed on the right side of the second tier are missing, and specifies these articles as target articles. As described above, the specifying unit 101A may automatically specify the target article.

The target article only needs to be an article to be transported, and is not limited to a missing article. For example, the specifying unit 101A may specify an article of which the quantity of shelf inventory is less than a predetermined lower limit value, as the target article. A method of specifying the target article is optional. For example, the specifying unit 101A may specify, as the target article, an article in which a value obtained by subtracting the shelf inventory quantity from the sales quantity of each article counted by the POS system or the like is less than a predetermined lower limit value.

The processing related to the assignment after the specifying unit 101A specifies the target article is similar to the case where the assignment is performed with reading of the identification information of the target article as a trigger. That is, the assignment unit 102A decides the cart to be used for transport of the target article based on the transport destination information indicating the transport destination of the target article and the transport destination of another article loaded on the cart, and the notification unit 105A makes a notification of the decided cart.

In the example of FIG. 9, the notification unit 105A notifies the worker f3 of the target article and the cart by displaying the specified target article and the cart assigned to the target article on a display device 4A installed in the backyard. As a result, the worker f3 can quickly replenish the article that is missing at the storefront. Also in the example of FIG. 9, decision of the route by the route decision unit 103A, decision of the loading order by the loading order decision unit 104A, and notification by the notification unit 105A of the decided route and the loading order may be performed.

### Flow of Processing: Case of Automatically Specifying Target Article

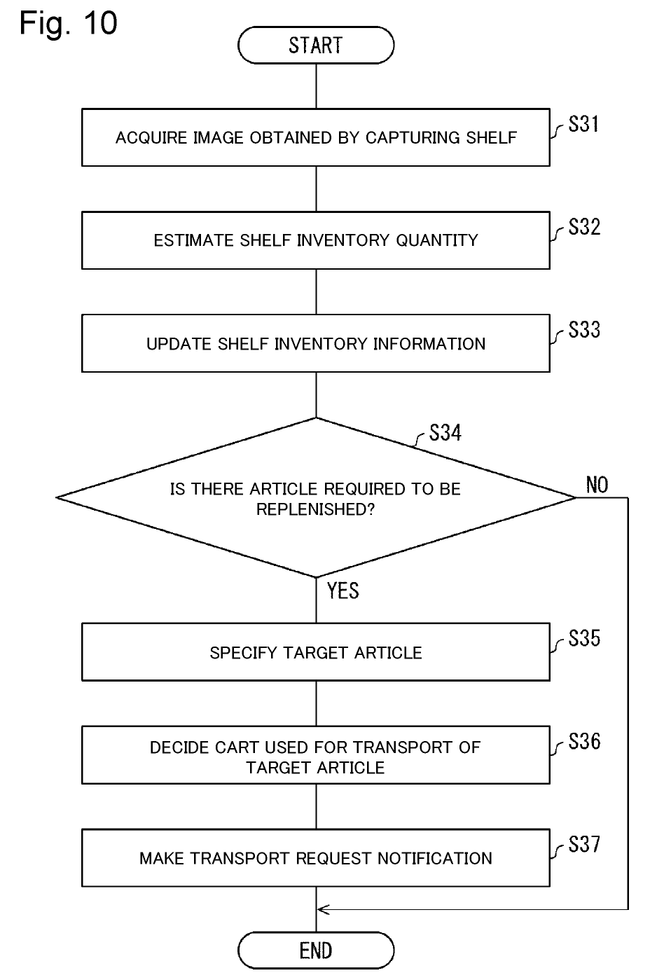

A flow of processing executed by the information processing apparatus 1A in a case where the target article is automatically specified will be described with reference to FIG. 10. FIG. 10 is a flowchart illustrating another example of the processing performed by the information processing apparatus 1A. Similar to the flowchart of FIG. 8, the flowchart of FIG. 10 includes each process of the work support method according to the present example embodiment.

In S31, the shelf inventory management unit 106A acquires an image obtained by capturing an image of a shelf. For example, as in the example of FIG. 9, the shelf inventory management unit 106A may acquire an image captured by the image capturing device 3A provided on the cart. For example, in a case where an image capturing device for monitoring each shelf is installed in advance, the shelf inventory management unit 106A may acquire an image captured by the image capturing device. For example, an image capturing device may be provided on a cart (so-called shopping cart) used by a customer for shopping. In this case, the shelf inventory management unit 106A may acquire an image captured by the image capturing device.

In S32, the shelf inventory management unit 106A estimates the shelf inventory quantity of the shelf appearing in the image at an image capturing time point of the image based on the image acquired in S31. This estimation method is optional. For example, the shelf inventory management unit 106A may detect each article appearing in the image by using a detection model that has been machine-learned in such a way as to detect a predetermined article in the image, and estimate the shelf inventory quantity based on the detection result.

In S33, the shelf inventory management unit 106A updates the shelf inventory information based on the estimation result of S32. The shelf inventory quantity may be estimated by a method other than image analysis, and in that case, in S31, information (for example, data of a POS system or the like) necessary for estimating the shelf inventory quantity may be acquired. The shelf inventory quantity may be checked manually, and in that case, the process of S33 and subsequent processes may be performed with the reception of the input of the shelf inventory quantity as a trigger.

In S34, the specifying unit 101A determines the presence or absence of an article that requires replenishment based on the shelf inventory information updated in S33. In a case where YES is determined in S34, the process proceeds to S35. In a case where NO is determined in S34, the processing of FIG. 10 ends. A criterion of necessity of replenishment may be determined in advance. For example, an article whose shelf inventory quantity is less than a predetermined lower limit value may be required to be replenished.

In S35 (specifying process), the specifying unit 101A specifies a target article that is an article as a target to be transported to a predetermined transport destination. Specifically, the specifying unit 101A specifies the article decided to be required to be replenished in S34, as the target article. The specifying unit 101A may also specify the number of replenishment target articles. The number of pieces of replenishment can be calculated, for example, from the shelf inventory quantity of the target article and the number of the target articles that can be displayed.

In S36 (assignment process), the assignment unit 102A decides a cart to be used for transport of the target article specified in S35, based on transport destination information indicating a transport destination of the target article and a transport destination of another article loaded on the cart. The assignment unit 102A may decide the cart based on the target article information including the transport destination information. Various types of information can be used as the target article information. For example, in addition to the transport destination information indicating the transport destination of the target article specified in S35 (the transport destination of each target article in a case where a plurality of target articles are specified), the assignment unit 102A may decide the cart by using information indicating the number of the target articles specified in S35 and characteristics (for example, weight, volume, and whether the target article is a refrigerated product or a room-temperature product) of the target article.

In S37, the notification unit 105A transmits a notification requesting the target article specified in S35 to be transported by the cart decided in S36, whereby the processing of FIG. 10 ends. A transmission destination of the notification may be determined in advance. For example, as in the example of FIG. 9, the above notification may be transmitted to the display device 4A arranged in a place that can be seen by the worker, or the above notification may be transmitted to the terminal device 2A held by each worker.

The processing of FIG. 10 may be performed, for example, when an image of the shelf is newly captured. The processing of FIG. 10 may be performed every predetermined time. In this case, in S31, an image captured after the previous processing of FIG. 10 (the latest image among a plurality of images obtained by capturing the same shelf) may be acquired.

Also in the example of FIG. 10, decision of the route by the route decision unit 103A, decision of the loading order by the loading order decision unit 104A, and notification by the notification unit 105A of the decided route and the loading order may be performed. Here, in a case where the inventory quantity is checked by using the image captured by the image capturing device 3A provided on the cart, the route decision unit 103A may set a route through a shelf having a high necessity of checking the inventory quantity. As a result, it is possible to capture an image of the shelf having a high necessity to confirm the inventory quantity at the time of replenishing the article to the shelf.

An evaluation method of the necessity of checking the inventory quantity may be determined in advance. For example, the information processing apparatus 1A may evaluate the necessity of check of the inventory quantity based on at least one of an elapsed time after last check of the inventory quantity, sales of the arranged article, and a deadline set for the arranged article. As a result, the route decision unit 103A can set a route through a shelf whose evaluation result indicates that the necessity of checking the inventory quantity is high.

### Regarding Automation of Transport Work

As described above, a cart to which a target article is assigned may be a self-propelled cart. In this case, it is also possible to automatically move the cart to a transport destination without involving a worker. By using a cart provided with a mechanism (for example, a robot arm and a robot hand) for performing unloading work and display work of the target article at the transport destination, these works can also be automated.

The loading work on a cart in the backyard or the like can also be automated by using a loading device. In this case, the target article specified by the specifying unit 101A and the cart assigned by the assignment unit 102A can be input to the loading device, and the target article can be loaded on the cart.

As described above, the information processing apparatus 1A can also be used for automation of transport work. The transport work may be shared by the automation mechanism and the worker as described above, and in such a case, by using the information processing apparatus 1A, it is also possible to perform assignment of the cart in such a way that efficient sharing is achieved.

### Modified Example

An executing entity of each processing described in the above-described example embodiments is optional, and is not limited to the above-described examples. For example, a system having functions similar to those of the information processing apparatuses 1 and 1A can be constructed by a plurality of devices capable of communicating with each other. The executing entity of each processing illustrated in the flowcharts of FIGS. 8 and 10 may be one device (may be rephrased as a processor) or a plurality of devices (may be similarly rephrased as processors).

### Exemplary Implementation by Software

Some or all of the functions of the information processing apparatuses 1 and 1A (hereinafter, also referred to as “each of the above apparatuses”) may be implemented by hardware such as an integrated circuit (IC chip) or may be implemented by software.

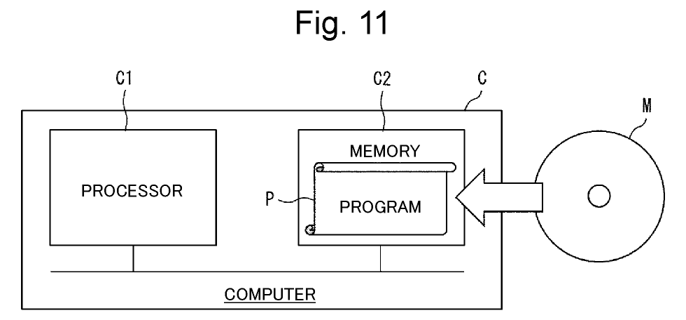

In the latter case, each of the above apparatuses is implemented by, for example, a computer that executes a command of a program as software for implementing each function. An example of such a computer (which will be referred to as a computer C hereinafter) is illustrated in FIG. 11. FIG. 11 is a block diagram illustrating a hardware configuration of the computer C that functions as each of the above apparatuses.

The computer C includes at least one processor C1 and at least one memory C2. A program (work support program) P for operating the computer C as each of the above apparatuses is recorded in the memory C2. In the computer C, the processor C1 reads the program P from the memory C2 and executes it, thereby implementing the functions of each of the above apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for developing the program P during execution and temporarily storing various types of data. The computer C may further include a communication interface for exchanging data with another device. The computer C may further include an input/output interface for connecting input/output devices such as a keyboard, a mouse, a display, and a printer.

The program P can be recorded in a non-transitory tangible recording medium M readable by the computer C. Examples of such a recording medium M may include a tape, a disk, a card, a semiconductor memory, and a programmable logic circuit. The computer C may obtain the program P via such a recording medium M. The program P may be transmitted via a transmission medium. Examples of such a transmission medium may include a communication network and a broadcast wave. The computer C can also acquire the program P via such a transmission medium.

Each of the above functions of each of the above apparatuses may be implemented by a single processor provided in a single computer, may be implemented in cooperation with a plurality of processors provided in a single computer, or may be implemented in cooperation with a plurality of processors provided in each of a plurality of computers. The program for causing each of the above apparatuses to implement each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Note Matter 1

The present disclosure includes the technologies described in the following Supplementary Notes. However, the present disclosure is not limited to the technique described in each of Supplementary Notes below, and various modifications can be made within the scope described in the claims.

### Supplementary Note A1

An information processing apparatus including: specifying means for specifying a target article that is an article as a target to be transported to a predetermined transport destination; and assignment means for deciding a cart to be used for transport of the target article based on transport destination information indicating a transport destination of the target article and a transport destination of another article loaded on the cart.

### Supplementary Note A2

The information processing apparatus according to Supplementary Note A1, in which the assignment means decides the cart to be used for transport of the target article based on the transport destination of the target article and the transport destination of the another article loaded on the cart that are indicated in the transport destination information, in such a way that a degree of dispersion at the transport destination when the target article is loaded is minimized.

### Supplementary Note A3

The information processing apparatus according to Supplementary Note A1 or A2, in which the specifying means specifies the target article by acquiring identification information of the target article read by a terminal device held by a worker who performs work of transporting the target article, from the terminal device, and the information processing apparatus further includes notification means for notifying the worker of the cart decided by the assignment means, via the terminal device.

### Supplementary Note A4

The information processing apparatus according to any one of Supplementary Notes A1 to A3, in which the assignment means decides the cart to be used for transport of the target article based on at least one of worker information regarding a worker who performs work of transporting the target article, cart information regarding a cart available for transport of the target article, and shelf inventory information regarding a shelf inventory quantity of the target article.

### Supplementary Note A5

The information processing apparatus according to any one of Supplementary Notes A1 to A4, in which the assignment means decides the cart to be used for transport of the target article based on constraint information indicating a constraint on an article to be loaded on the same cart.

### Supplementary Note A6

The information processing apparatus according to any one of Supplementary Notes A1 to A5, further including route decision means for deciding a route of transport by the cart decided by the assignment means based on a transport destination of each article to be loaded on the cart.

### Supplementary Note A7

The information processing apparatus according to Supplementary Note A6, in which the route decision means decides the route of transport by the cart decided by the assignment means based on the transport destination of each article to be loaded on the cart decided by the assignment means and at least one of worker information regarding a worker who performs work of transporting the target article, cart information regarding the cart decided by the assignment means, and shelf inventory information regarding a shelf inventory quantity of the target article.

### Supplementary Note A8

The information processing apparatus according to Supplementary Note A6 or A7, further including loading order decision means for deciding a loading order of the target article and another article onto the cart decided by the assignment means based on the route decided by the route decision means.

### Supplementary Note B1

A work support method including: by at least one processor, a specifying process of specifying a target article that is an article as a target to be transported to a predetermined transport destination; and an assignment process of deciding a cart to be used for transport of the target article based on transport destination information indicating a transport destination of the target article and a transport destination of another article loaded on the cart.

### Supplementary Note B2

The work support method according to Supplementary Note B1, in which the assignment process includes deciding the cart to be used for transport of the target article based on the transport destination of the target article and the transport destination of the another article loaded on the cart that are indicated in the transport destination information, in such a way that a degree of dispersion at the transport destination when the target article is loaded is minimized.

### Supplementary Note B3

The work support method according to Supplementary Note B1 or B2, in which, in the specifying process, the at least one processor specifies the target article by acquiring identification information of the target article read by a terminal device held by a worker who performs work of transporting the target article, from the terminal device, and the work support method further includes a notification process of notifying the worker of the cart decided by the assignment process, via the terminal device, by the at least one processor.

### Supplementary Note B4

The work support method according to any one of Supplementary Notes B1 to B3, in which, in the assignment process, the at least one processor decides the cart to be used for transport of the target article based on at least one of worker information regarding a worker who performs work of transporting the target article, cart information regarding a cart available for transport of the target article, and shelf inventory information regarding a shelf inventory quantity of the target article.

### Supplementary Note B5

The work support method according to any one of Supplementary Notes B1 to B4, in which, in the assignment process, the at least one processor decides the cart to be used for transport of the target article based on constraint information indicating a constraint on an article to be loaded on the same cart.

### Supplementary Note B6

The work support method according to any one of Supplementary Notes B1 to B5, further including a route decision process of deciding a route of transport by the cart decided in the assignment process, based on a transport destination of each article to be loaded on the cart, by the at least one processor.

### Supplementary Note B7

The work support method according to Supplementary Note B6, in which, in the route decision process, the at least one processor decides the route of transport by the cart decided in the assignment process, based on the transport destination of each article to be loaded on the cart decided in the assignment process and at least one of worker information regarding a worker who performs work of transporting the target article, cart information regarding the cart decided in the assignment process, and shelf inventory information regarding a shelf inventory quantity of the target article.

### Supplementary Note B8

The work support method according to Supplementary Note B6 or B7, in which the at least one processor executes a loading order process of deciding a loading order of the target article and another article onto the cart decided in the assignment process, based on the route decided in the route decision process

### Supplementary Note C1

A work support program for causing a computer to function as: specifying means for specifying a target article that is an article as a target to be transported to a predetermined transport destination; and assignment means for deciding a cart to be used for transport of the target article based on transport destination information indicating a transport destination of the target article and a transport destination of another article loaded on the cart.

### Supplementary Note C2

The work support program according to Supplementary Note C1, in which the assignment means decides the cart to be used for transport of the target article based on the transport destination of the target article and the transport destination of the another article loaded on the cart that are indicated in the transport destination information, in such a way that a degree of dispersion at the transport destination when the target article is loaded is minimized.

### Supplementary Note C3

The work support program according to Supplementary Note C1 or C2, in which the specifying means specifies the target article by acquiring identification information of the target article read by a terminal device held by a worker who performs work of transporting the target article, from the terminal device, and the computer is caused to function as notification means for notifying the worker of the cart decided by the assignment means, via the terminal device.

### Supplementary Note C4

The work support program according to any one of Supplementary Notes C1 to C3, in which the assignment means decides the cart to be used for transport of the target article based on at least one of worker information regarding a worker who performs work of transporting the target article, cart information regarding a cart available for transport of the target article, and shelf inventory information regarding a shelf inventory quantity of the target article.

### Supplementary Note C5

The work support program according to any one of Supplementary Notes C1 to C4, in which the assignment means decides the cart to be used for transport of the target article based on constraint information indicating a constraint on an article to be loaded on the same cart.

### Supplementary Note C6

The work support program according to any one of Supplementary Notes C1 to C5, in which the computer is caused to function as route decision means for deciding a route of transport by the cart decided by the assignment means based on a transport destination of each article to be loaded on the cart.

### Supplementary Note C7

The work support program according to Supplementary Note C6, in which the route decision means decides the route of transport by the cart decided by the assignment means based on the transport destination of each article to be loaded on the cart decided by the assignment means and at least one of worker information regarding a worker who performs work of transporting the target article, cart information regarding the cart decided by the assignment means, and shelf inventory information regarding a shelf inventory quantity of the target article.

### Supplementary Note C8

The work support program according to Supplementary Note C6 or C7, in which the computer is caused to function as loading order decision means for deciding a loading order of the target article and another article onto the cart decided by the assignment means based on the route decided by the route decision means.

### Supplementary Note D1

An information processing apparatus including at least one processor that executes a specifying process of specifying a target article that is an article as a target to be transported to a predetermined transport destination; and an assignment process of deciding a cart to be used for transport of the target article based on transport destination information indicating a transport destination of the target article and a transport destination of another article loaded on the cart.

The information processing apparatus may further include a memory. The memory may store a program for causing the at least one processor to execute the above processing.

### Supplementary Note D2

The information processing apparatus according to Supplementary Note D1, in which the assignment process includes deciding the cart to be used for transport of the target article based on the transport destination of the target article and the transport destination of the another article loaded on the cart that are indicated in the transport destination information, in such a way that a degree of dispersion at the transport destination when the target article is loaded is minimized.

### Supplementary Note D3

The information processing apparatus according to Supplementary Note D1 or D2, in which, in the specifying process, the at least one processor specifies the target article by acquiring identification information of the target article read by a terminal device held by a worker who performs work of transporting the target article, from the terminal device, and the at least one processor executes a notification process of notifying the worker of the cart decided in the assignment process, via the terminal device.

### Supplementary Note D4

The information processing apparatus according to any one of Supplementary Notes D1 to D3, in which, in the assignment process, the at least one processor decides the cart to be used for transport of the target article based on at least one of worker information regarding a worker who performs work of transporting the target article, cart information regarding a cart available for transport of the target article, and shelf inventory information regarding a shelf inventory quantity of the target article.

### Supplementary Note D5

The information processing apparatus according to any one of Supplementary Notes D1 to D4, in which, in the assignment process, the at least one processor decides the cart to be used for transport of the target article based on constraint information indicating a constraint on an article to be loaded on the same cart.

### Supplementary Note D6

The information processing apparatus according to any one of Supplementary Notes D1 to D5, in which the at least one processor executes a route decision process of deciding a route of transport by the cart decided in the assignment process based on a transport destination of each article to be loaded on the cart.

### Supplementary Note D7

The information processing apparatus according to Supplementary Note D6, in which, in the route decision process, the at least one processor decides the route of transport by the cart decided in the assignment process, based on the transport destination of each article to be loaded on the cart decided in the assignment process and at least one of worker information regarding a worker who performs work of transporting the target article, cart information regarding the cart decided in the assignment process, and shelf inventory information regarding a shelf inventory quantity of the target article.

### Supplementary Note D8

The information processing apparatus according to Supplementary Note D6 or D7, in which the at least one processor executes a loading order process of deciding a loading order of the target article and another article onto the cart decided in the assignment process, based on the route decided in the route decision process.

### Supplementary Note E

A non-transitory recording medium recording a work support program for causing a computer to execute: a specifying process of specifying a target article that is an article as a target to be transported to a predetermined transport destination; and an assignment process of deciding a cart to be used for transport of the target article based on transport destination information indicating a transport destination of the target article and a transport destination of another article loaded on the cart.

1. An information processing apparatus comprising:
a memory configured to store instructions; and
at least one processor configured to execute the instructions to:
specify a target article that is an article as a target to be transported to a predetermined transport destination; and
decide a cart to be used for transport of the target article based on transport destination information indicating a transport destination of the target article and a transport destination of another article loaded on the cart.

2. The information processing apparatus according to claim 1, wherein
the at least one processor is further configured to execute the instructions to:
decide the cart to be used for transport of the target article based on the transport destination of the target article and the transport destination of the another article loaded on the cart that are indicated in the transport destination information, in such a way that a degree of dispersion at the transport destination when the target article is loaded is minimized.

3. The information processing apparatus according to claim 1, wherein
the at least one processor is further configured to execute the instructions to:
specify the target article by acquiring identification information of the target article read by a terminal device held by a worker who performs work of transporting the target article, from the terminal device; and
notify the worker of the decided cart via the terminal device.

4. The information processing apparatus according to claim 1, wherein
the at least one processor is further configured to execute the instructions to:
decide the cart to be used for transport of the target article based on at least one of worker information regarding a worker who performs work of transporting the target article, cart information regarding a cart available for transport of the target article, and shelf inventory information regarding a shelf inventory quantity of the target article.

5. The information processing apparatus according to claim 1, wherein
the at least one processor is further configured to execute the instructions to:
decide the cart to be used for transport of the target article based on constraint information indicating a constraint on an article to be loaded on the same cart.

6. The information processing apparatus according to claim 1, wherein
the at least one processor is further configured to execute the instructions to:
decide a route of transport by the decided cart based on a transport destination of each article to be loaded on the decided cart.

7. The information processing apparatus according to claim 6, wherein
the at least one processor is further configured to execute the instructions to:
decide the route of transport by the decided cart decided based on the transport destination of each article to be loaded on the decided cart and at least one of worker information regarding a worker who performs work of transporting the target article, cart information regarding the decided cart, and shelf inventory information regarding a shelf inventory quantity of the target article.

8. The information processing apparatus according to claim 6, wherein
the at least one processor is further configured to execute the instructions to:
decide a loading order of the target article and another article onto the decided cart based on the decided route.

9. A work support method comprising:
by at least one processor,
specifying a target article that is an article as a target to be transported to a predetermined transport destination; and
deciding a cart to be used for transport of the target article based on transport destination information indicating a transport destination of the target article and a transport destination of another article loaded on the cart.

10. A non-transitory computer-readable recording medium storing a work support program for causing a computer to execute the steps:
specifying a target article that is an article as a target to be transported to a predetermined transport destination; and
deciding a cart to be used for transport of the target article based on transport destination information indicating a transport destination of the target article and a transport destination of another article loaded on the cart.
